(19) United States
(12) Patent Application Publication
(10) Pub. No.: US 2013/0274943 A1
(43) Pub. Date: Oct. 17, 2013

(54) CONTROLLER, NETWORK SYSTEM AND INFORMATION PROCESSING METHOD

(71) Applicants: Mitsunori Nojima, Osaka-shi (JP); Yohhei Iwami, Osaka-shi (JP); Hirosuke Miki, Osaka-shi (JP); Ryousuke Kurita, Osaka-shi (JP)

(72) Inventors: Mitsunori Nojima, Osaka-shi (JP); Yohhei Iwami, Osaka-shi (JP); Hirosuke Miki, Osaka-shi (JP); Ryousuke Kurita, Osaka-shi (JP)

(73) Assignee: SHARP KABUSHIKI KAISHA, Osaka-shi, Osaka (JP)

(21) Appl. No.: 13/996,096

(22) PCT Filed: Dec. 22, 2011
(86) PCT No.: PCT/JP2011/079775

§ 371 Date: Jun. 20, 2013

(30) Foreign Application Priority Data
Dec. 24, 2010 (JP) 2010-288020

(51) Int. Cl. G05F 3/04

(52) U.S. Cl. CPC G05F 3/04
USPC 700/295

(57) ABSTRACT

Provided is a controller capable of making a user aware of a consumption amount of electricity at a preferred time. A home controller (100) includes a communication interface (105) configured to receive an electrical power consumption of a plurality of devices (200A to 200E), a memory (101) configured to store changes in the electrical power consumption of the plurality of devices (200A to 200E), and a processor (110) configured to determine whether or not a change amount or a change rate in the electrical power consumption is greater than a predefined range for each of the plurality of devices (200A to 200E) and output information indicating the electrical power consumption of a device having the change amount or the change rate in the electrical power consumption greater than the predefined range.

### TECHNICAL FIELD

The present invention relates to a technique of a controller which is disposed in a home or the like and is connected to an electrical device in the home.

### BACKGROUND ART

There has been proposed a controller which is disposed in a home or the like and configured to control an electrical device in the home. For example, there has been proposed a technique for causing a controller to control home electrical appliances such as a washing machine, a microwave oven, a refrigerator, an air conditioner, a television and/or a photovoltaic cell and to display conditions of these home electrical appliances.

Japanese Patent Laying-Open No. 09-145743 (PTD 1) discloses an adaptor detecting an electrical current consumption and an application system thereof. According to Japanese Patent Laying-Open No. 09-145743 (PTD 1), a flow of an electrical current into a device is detected by an electrical current flow detecting circuit section, and when the electrical current flow is abnormally great, the electrical current can be blocked off by an electrical current block-off circuit section according to an instruction transmitted from a control processing section. Through a communication processing section, the detected electrical current flow or electrical current flow control information can be transmitted to or received from a controller lined in a bus, which makes it possible to know utilization states of a plurality of devices and to determine whether or not they are working normally.

### CITATION LIST

### Patent Document

PTD 1: Japanese Patent Laying-Open No. 09-145743

### SUMMARY OF INVENTION

### Technical Problem

Currently, from the viewpoint of environmental conservation, it is required to further improve energy-saving consciousness of a user utilizing a home electrical appliance. For example, it is beneficial if it is possible to make the user aware of a consumption amount of electricity at a preferred time in accordance with a utilization state of a home electrical appliance.

The present invention has been accomplished in view of the aforementioned problems, and it is therefore an object of the present invention to provide a controller, a network system and an information processing method capable of making a user aware of a consumption amount of electricity at a preferred time.

### Solution to Problem

An aspect of the present invention provides a controller which includes a communication interface configured to receive an electrical power consumption of a plurality of devices, a memory configured to store changes in the electrical power consumption of the plurality of devices, and a processor configured to determine whether or not a change amount or a change rate in the electrical power consumption is greater than a predefined range for each of the plurality of devices and output information indicating the electrical power consumption of a device for which the change amount or the change rate in the electrical power consumption is greater than the predefined range.

Preferably, the controller further includes a display. When the change amount or the change rate in the electrical power consumption of a device is greater than the predefined range, the processor causes the display to display the information indicating the electrical power consumption of the device for which the change amount or the change rate in the electrical power consumption is greater than the predefined range.

Preferably, the controller further includes an input unit. The processor causes the display to display an image of notification when the change amount or the change rate in the electrical power consumption of a device is greater than the predefined range, and causes the display to display the information indicating the electrical power consumption of the device for which the change amount or the change rate in the electrical power consumption is greater than the predefined range in accordance with a display instruction input from the input unit.

Preferably, the communication interface is capable of communicating with an external display device. The processor causes, through the intermediary of the communication interface, the external display device to display an image of notification when the change amount or the change rate in the electrical power consumption of a device is greater than the predefined range, and causes, through the intermediary of the communication interface, the external display device to display the information indicating the electrical power consumption of the device for which the change amount or the change rate in the electrical power consumption is greater than the predefined range in accordance with an input of a display instruction.

Preferably, the processor outputs a graph indicating temporal changes in the electrical power consumption as the information indicating the electrical power consumption of the device for which the change amount or the change rate in the electrical power consumption is greater than the predefined range.

Preferably, the processor outputs the graph by making a portion of the graph where the change amount or the change rate of the electrical power consumption is greater than the predefined range different from the other portions thereof.

Preferably, the processor, through the intermediary of the communication interface, receives the electrical power consumption from each of the plurality of devices.

Preferably, the processor, through the intermediary of the communication interface, receives instructions input from each device of the plurality of devices, stores in the memory the instructions associated with the device, and outputs at least one latest instruction associated with the device for which the change amount or the change rate in the electrical power consumption is greater than the predefined range together with the information indicating the electrical power consumption of the same device for which the change amount or the change rate in the electrical power consumption is greater than the predefined range.

Preferably, the processor, through the intermediary of the communication interface, receives the electrical power consumption from a plurality of communication units configured to measure the electrical power consumption of each of the plurality of devices.

Another aspect of the present invention provides a network system which includes a plurality of devices and a controller. Each of the plurality of devices is configured to transmit an electrical power consumption to the controller. The controller includes: a communication interface configured to receive the electrical power consumption from the plurality of devices;

a memory configured to store changes in the electrical power consumption of the plurality of devices; and a processor configured to determine whether or not a change amount or a change rate in the electrical power consumption is greater than a predefined range for each of the plurality of devices and output information indicating the electrical power consumption of a device for which the change amount or the change rate in the electrical power consumption is greater than the predefined range.

Another aspect of the present invention provides a network system which includes a plurality of devices, a plurality of measuring units configured to measure an electrical power consumption of each of the plurality of devices, and a controller. The plurality of measuring units are each configured to transmit the electrical power consumption of each of the plurality of devices to the controller. The controller includes: a communication interface configured to receive the electrical power consumption of the plurality of devices from the plurality of measuring units; a memory configured to store changes in the electrical power consumption of the plurality of devices; and a processor configured to determine whether or not a change amount or a change rate in the electrical power consumption is greater than a predefined range for each of the plurality of devices and output information indicating the electrical power consumption of a device for which the change amount or the change rate in the electrical power consumption is greater than the predefined range.

Another aspect of the present invention provides an information processing method for a controller including a communication interface, a memory and a processor. The information processing method includes the steps of: receiving, by the processor, an electrical power consumption of each of a plurality of devices through the intermediary of the communication interface; storing, by the memory, changes in the electrical power consumption of each of the plurality of devices; determining, by the processor, whether or not a change amount or a change rate in the electrical power consumption is greater than a predefined range for each of the plurality of devices; and outputting, by the processor, information indicating the electrical power consumption of a device for which the change amount or the change rate in the electrical power consumption is greater than the predefined range.

### Advantageous Effects of Invention

As mentioned above, the present invention provides a controller, a network system and an information processing method capable of making a user aware of a consumption amount of electricity at a preferred time.

### BRIEF DESCRIPTION OF DRAWINGS

FIG. 1 is a schematic view illustrating an overall configuration of a network system 1 according to Embodiment 1;

FIG. 2 is a schematic view illustrating a display 102 of a home controller 100 or a display 202 of a television 200B according to the present embodiment;

FIG. 3 is a block view illustrating a hardware configuration of home controller 100 according to the present embodiment;

FIG. 4 is a schematic view illustrating an electrical power consumption table 101A according to the present embodiment;

FIG. 5 is a schematic view illustrating an event table 101B according to the present embodiment;

FIG. 6 is a block view illustrating a hardware configuration of television 200B according to the present embodiment;

FIG. 7 is a flow chart illustrating a procedure of an information processing by home controller 100 according to Embodiment 1;

FIG. 8 is a schematic view illustrating a graph 102A displayed on display 102 and/or 202 immediately (several seconds) after a change amount becomes equal to or greater than a predefined value;

FIG. 9 is a flow chart illustrating a procedure of an information processing by television 200B according to Embodiment 1;

FIG. 10 is a schematic view illustrating an overall configuration of a network system 1B according to Embodiment 2;

FIG. 11 is a flow chart illustrating a procedure of an information processing by home controller 100 according to Embodiment 2; and

FIG. 12 is a flow chart illustrating a procedure of an information processing by television 200B according to Embodiment 2.

### DESCRIPTION OF EMBODIMENTS

Hereinafter, embodiments of the present invention will be described with reference to the drawings. In the following description, identical parts will be assigned with identical numeral numbers, and names and functions thereof will the same; thereby, the detailed description thereof will not be repeated.

### Embodiment 1

<Overall Configuration of Network System>

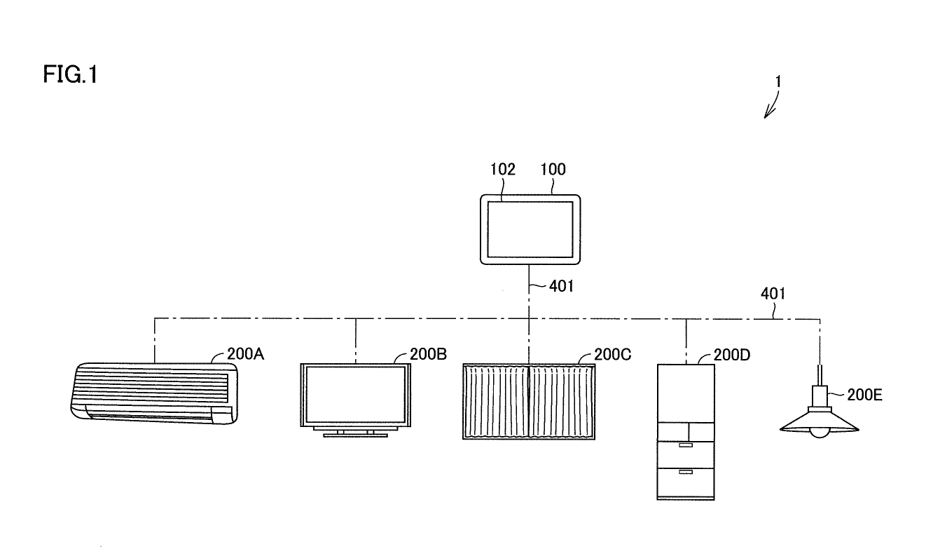

Firstly, the overall configuration of a network system according to the present embodiment will be described. FIG. 1 is a schematic view illustrating the overall configuration of a network system 1 according to the present embodiment.

With reference to FIG. 1, network system 1 according to the present embodiment is disposed, for example, in a home or an office room. Network system 1 includes home electrical appliances (electrical devices) such as an air conditioner 200A set in a living room, a television 200B set in a living room, a curtain device 200C set in a living room, a refrigerator 200D set in a kitchen, and a light 200E set in a dining room. It is acceptable for network system 1 to include the other home electrical appliances.

Network system 1 includes a home controller 100 configured to control home electrical appliances 200A-200E. Home controller 100 is capable of communicating data with home electrical appliances 200A-200E through the intermediary of a wired or wireless network 401. For example, a wireless LAN (Local Area Network), ZigBee (registered trademark), Bluetooth (registered trademark), a wired LAN, or a PLC (Power Line Communications) may be used by home controller 100 as network 401. Home controller 100 may be portable, or may be detachably installed on a base placed on a table, or may be fixed on a wall of a room.

<Operation Summary of Network System>

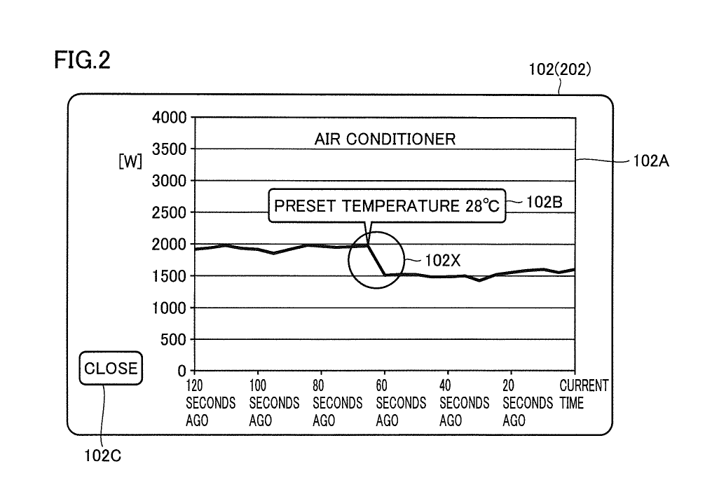

Hereinafter, operations of network system 1 according to the present invention will be summarized. FIG. 2 is a schematic view illustrating a display 102 of home controller 100 or a display 202 of television 200B according to the present embodiment. In the following, television 200B is described as an example of an external display device; however, the external display device in the present invention is not limited to television 200B, and it may be any device having a display section, such as a portable terminal or a tablet terminal.

With reference to FIGS. 1 and 2, through the intermediary of network 401, home controller 100 according to the present embodiment receives an electrical power consumption, an operation state, an input instruction and the like of home electrical appliances 200A-200E from each of a plurality of home electrical appliances 200A-200E disposed in the home.

Home controller 100 determines whether or not there is a great change in the electrical power consumption of home electrical appliances 200A-200E on the basis of a collection of a change history of the electrical power consumption of home electrical appliances 200A-200E. For example, home controller 100 determines whether or not a change amount or a change rate in the electrical power consumption is greater than a predefined range.

Home controller 100 causes a graph 102A indicating changes in the electrical power consumption of a home electrical appliance to be displayed on display 102 when the home electrical appliance has a great change in the electrical power consumption. Alternatively, home controller 100 causes graph 102A to be displayed on display 202 of television 200B.

More specifically, home controller 100 causes display 102 or display 202 to display an image (a pop-up window) indicating that there is a great change in the electrical power consumption. Home controller 100 causes display 102 or display 202 to display graph 102A in accordance with a display instruction for a detail screen from a user.

Home controller 100 makes a display mode of a portion of the displayed graph where there is a great change in the electrical power consumption different from the display mode of the other portions. For example, home controller 100 may thicken lines in the portion where there is a great change in the electrical power consumption, may change the color of the lines, or may blink the lines.

Home controller 100 collects operation states of home electrical appliances 200A-200E and input instructions (all will be collectively referred to as event). When there is a great change in the electrical power consumption of any home electrical appliance among home electrical appliances 200A-200E, home controller 100 displays, on graph 102A, the latest operation state and the latest input instruction of the same home electrical appliance among home electrical appliances 200A-200E where there is a great change in the electrical power consumption.

It is acceptable that home controller 100 displays graph 102A only when the change amount or the change rate in the electrical power consumption becomes great positively, and it is also acceptable that home controller 100 displays graph 102A when the change amount or the change rate in the electrical power consumption becomes great either positively or negatively.

As mentioned above, network system 1 according to the present embodiment can notify the user that there is a great change in the electrical power consumption of home electrical appliances 200A-200E when it occurs. In other words, home controller 100 is capable of making a user aware of the electrical power consumption at a timing when there is a great change in the electrical power consumption.

Hereinafter, the specific configuration of network system 1 for implementing the functions mentioned above will be described in detail.

<Hardware Configuration of Home Controller 100>

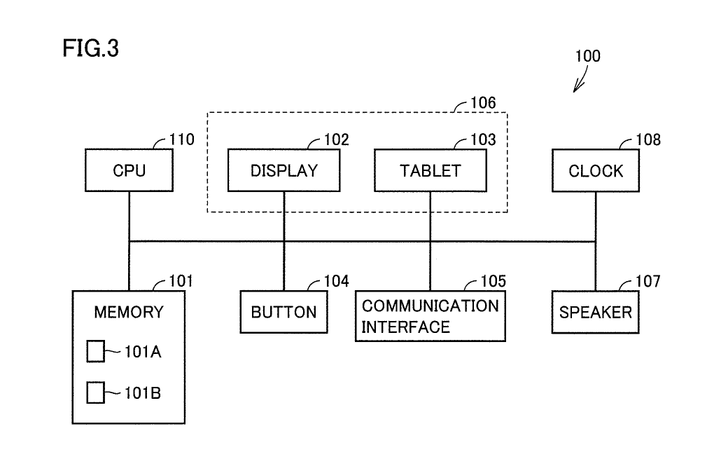

An example of a hardware configuration of home controller 100 according to the present embodiment will be described. FIG. 3 is a block view illustrating a hardware configuration of home controller 100 according to the present embodiment.

Home controller 100 includes a memory 101, display 102, a tablet 103, a button 104, a communication interface 105, a speaker 107, a clock 108, and a CPU (Central Processing Unit) 110.

Memory 101 is embodied by any type of RAM (Random Access Memory), a ROM (Read-Only Memory), a hard disk or the like. For example, memory 101 is embodied by any nonvolatile medium capable of storing a program, such as a USB (Universal Serial Bus) memory, a CD-ROM (Compact Disk-Read Only Memory), a DVD-ROM (Digital Versatile Disk-Read Only Memory), a memory card, a FD (Flexible Disk), a hard disk, an electromagnetic tape, a cassette tape, a MO (Magnetic Optical Disc), a MD (Mini Disc), an IC (Integrated Circuit) card (excluding the memory card), an optical card, a mask ROM, an EPROM, or an EEPROM (Electronically Erasable Programmable Read-Only Memory), which is used through a reading interface.

Memory 101 stores a control program to be executed by CPU 110, an electrical power consumption table 101A, and an event table 101B.

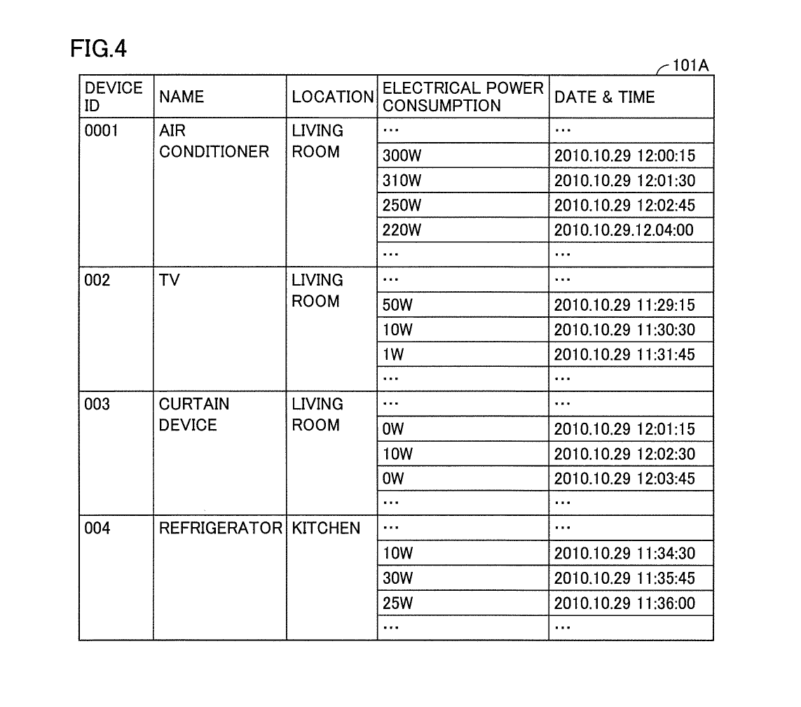

FIG. 4 is a schematic view illustrating electrical power consumption table 101A according to the present embodiment. With reference to FIG. 4, electrical power consumption table 101A stores the name of each home electrical appliance, a location where each home electrical appliance is disposed, and the electrical power consumption for each of home electrical appliances 200A-200E in association with each home electrical appliance ID. More specifically, electrical power consumption table 101A stores the value of the electrical power consumption received from each of home electrical appliances 200A-200E in association with the date and time at which the value of the electrical power consumption has been received (measured).

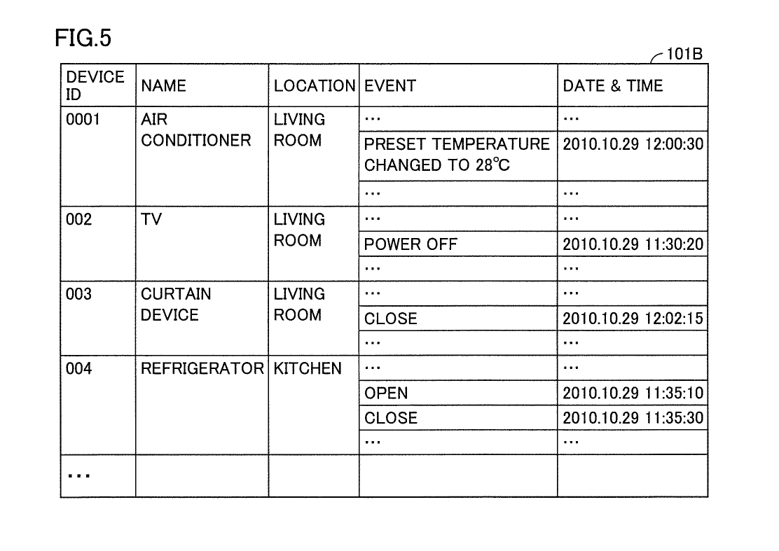

FIG. 5 is a schematic view illustrating event table 101B according to the present embodiment. With reference to FIG. 5, event table 101B stores the name of each home electrical appliance, a location where each home electrical appliance is disposed, and the operation state and input instructions (events) for each of home electrical appliances 200A-200E in association with each home electrical appliance ID. More specifically, event table 101B stores each event received from each of home electrical appliances 200A-200E in association with the date and time at which the corresponding event (or the date and time where each event was input to each of home electrical appliances 200A-200E) has been received.

In the above description regarding FIGS. 4 and 5, information about the name of a home electrical appliance associated with a home electrical appliance ID and the location where the home electrical appliance is disposed has been described illustratively as being stored in electrical power consumption table 101A and event table 101B; however, the present invention is not limited thereto. For example, it is acceptable that the name of a home electrical appliance associated with a home electrical appliance ID and the location where the home electrical appliance is disposed are stored in a different table. Moreover, it is acceptable that the aforementioned different table is not stored in memory 101. The aforementioned different table may be stored, for example, in an external memory separate from home controller 100.

Returning back to FIG. 3, display 102 is controlled by CPU 110 to display the states of home electrical appliances 200A-200E. Touch operations through the movements of fingers of the user on tablet 103 are detected, and thereby touch coordinates and the like are input to CPU 110. CPU 110 receives instructions from the user through the intermediary of tablet 103.

In the present embodiment, tablet 103 is built on the surface of display 102. In other words, in the present embodiment, display 102 and tablet 103 construct a touch panel 106. However, it is acceptable that home controller 100 does not include tablet 103.

Button 104 is disposed on the surface of home controller 100. It is acceptable that a plurality of buttons including an enter key, cursor arrow keys, a numeric keypad and the like are disposed in home controller 100. Button 104 accepts instructions from the user. The instructions from the user are input to CPU 110 through button 104.

Communication interface 105 is controlled by CPU 110 to transmit data to or receive data from home electrical appliances 200A-200E through the intermediary of network 401. As mentioned above, communication interface 105 transmits data to or receives data from home electrical appliances 200A-200E through the use of a wireless LAN, ZigBee (registered trademark), Bluetooth (registered trademark), a wired LAN, a PLC or the like.

Speaker 107 outputs voices on the basis of instructions from CPU 110. For example, CPU 110 causes speaker 107 to output voices on the basis of voice data.

Clock 108 inputs current date and current time to CPU 110 on the basis of instructions from CPU 110.

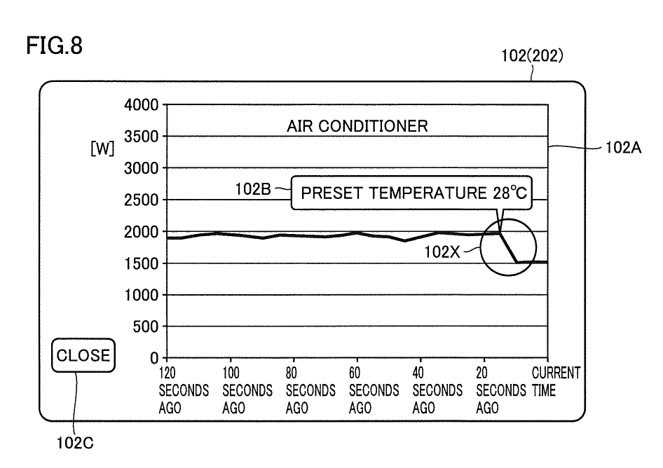

CPU 110 executes an information processing procedure and the like illustrated in FIG. 8, which will be described hereinafter, through executing various programs stored in memory 101. In other words, the processing in home controller 100 is implemented by various hardware and software executed by CPU 110. Such software may be preliminarily stored in memory 101. Further, such software may be stored in a storage medium to be distributed as a program product. Furthermore, such software may be a downloadable program product which is provided by an information provider accessible through the Internet.

Such software is read from the storage medium by using a reading device (not shown) or downloaded by using communication interface 105, and is temporarily stored in memory 101. After the software is stored in memory 101 in the form of an executable program, CPU 110 executes the program.

As an example of the storage medium, any nonvolatile medium capable of storing a program, such as a CD-ROM (Compact Disk-Read Only Memory), a DVD-ROM (Digital Versatile Disk-Read Only Memory), a USB (Universal Serial Bus) memory, a memory card, a FD (Flexible Disk), a hard disk, an electromagnetic tape, a cassette tape, a MO (Magnetic Optical Disc), a MD (Mini Disc), an IC (Integrated Circuit) card (excluding the memory card), an optical card, a mask ROM, an EPROM, or an EEPROM (Electronically Erasable Programmable Read-Only Memory) may be given.

The program here includes not only a program executable by CPU directly but also a program in the form of a source program, a compressed program, an encoded program or the like. In the above description, the configuration including touch panel 106 is given as an example of home controller 100; however, in the case where network system 1 includes an external display device (such as television 200B or the like), it is acceptable that home controller 100 does not include touch panel 106, that is to say that home controller 100 does not have a display function.

<Hardware Configuration of Television 200B>

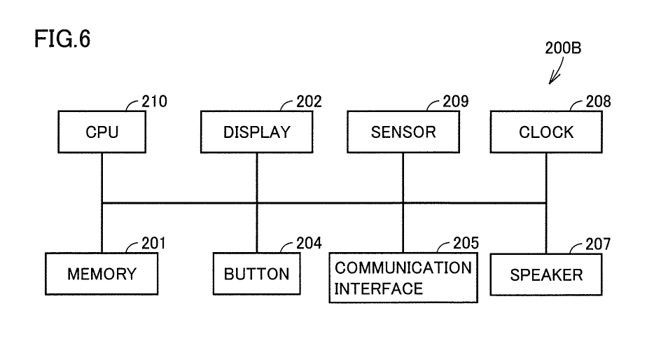

An example of a hardware configuration of television 200B according to the present embodiment will be described. FIG. 6 is a block view illustrating a hardware configuration of television 200B according to the present embodiment.

With reference to FIG. 6, television 200B includes a memory 201, display 202, a button 204, a communication interface 205, a speaker 207, a sensor 209, and a CPU 210.

Memory 201 may be embodied in the same way as memory 101 of home controller 100. Memory 201 stores a control program to be executed by CPU 210, the electrical power consumption by television 200B, an input instruction input to television 200B, an operation state of television 200B and the like.

Display 202 is controlled by CPU 210. More specifically, display 202 displays static images and/or dynamic images on the basis of data from a TV tuner and/or VRAM (Video RAM) not shown in the drawings.

Button 204 is disposed on the surface of television 200B. It is acceptable that television 200B is provided with a plurality of buttons 204 including an enter key, cursor arrow keys, a numeric keypad and the like. Button 204 accepts instructions from the user, and the instructions from the user are input to CPU 210 through button 204.

Communication interface 205 is controlled by CPU 210 to transmit data to or receive data from home controller 100 through the intermediary of network 401. As mentioned above, communication interface 205 transmits data to or receives data from home controller 100 through the use of a wireless LAN (Local Area Network), ZigBee (registered trademark), Bluetooth (registered trademark), a wired LAN, or a PLC (Power Line Communications).

Speaker 207 outputs voices on the basis of instructions from CPU 210. For example, CPU 210 causes speaker 207 to output voices on the basis of voice data.

Clock 208 inputs current date and current time to CPU 210 on the basis of instructions from CPU 210.

Sensor 209 measures the electrical power consumption by television 200B and transmits the electrical power consumption to CPU 210.

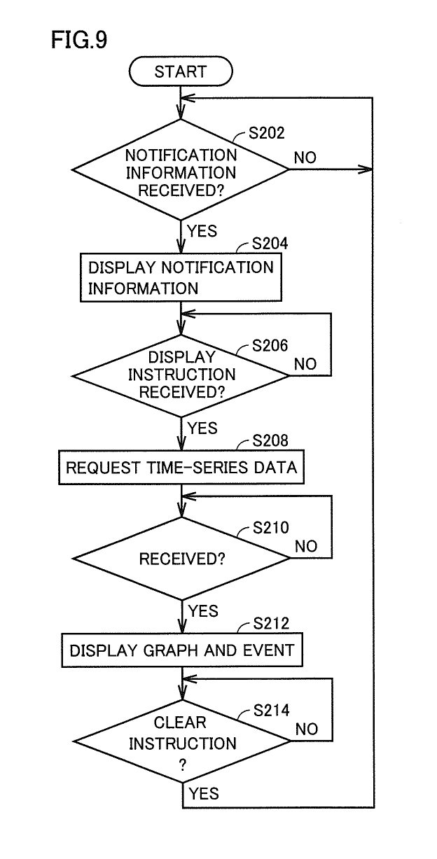

CPU 210 executes an information processing procedure in FIG. 9, which will be described hereinafter, through executing various programs stored in memory 201. In other words, the processing in television 200B is implemented by various hardware and software executed by CPU 210. Such software may be preliminarily stored in memory 201. Further, such software may be stored in a storage medium to be distributed as a program product. Furthermore, such software may be a downloadable program product which is provided by an information provider accessible through the Internet.

Such software is read from the storage medium by using a reading device (not shown) or downloaded by using communication interface 205 and is stored temporarily in memory 201. After the software is stored in memory 201 in the form of an executable program, CPU 210 executes the program. The storage medium and the program may be embodied in the same way as the storage medium and the program related to home controller 100.

<Home Electrical Appliances 200A-200E>

Similarly to television 200B illustrated in FIG. 6, home electrical appliances 200A-200E according to the present embodiment may be provided with sensor 209 for measuring the electrical power consumption, an input section (button 204) for accepting instructions from the user, and communication interface 205 for transmitting the electrical power consumption and events to home controller 100.

<Information Processing in Home Controller 100>

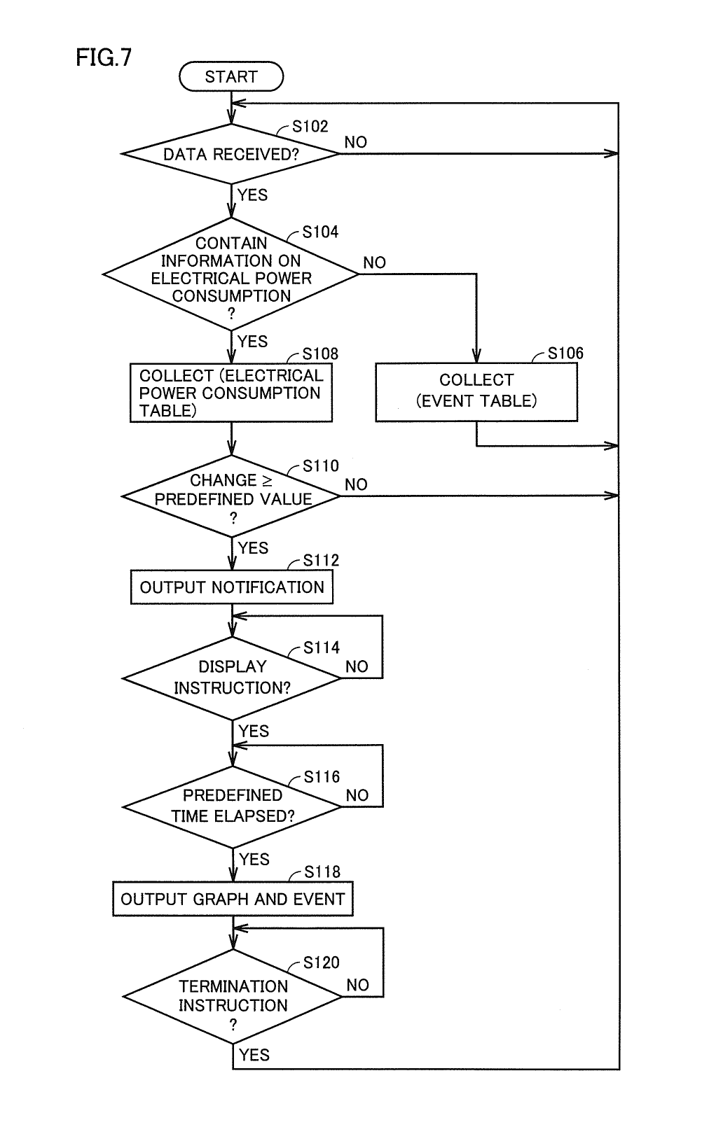

Hereinafter, the information processing in home controller 100 according to the present embodiment will be described. FIG. 7 is a flow chart illustrating a procedure of the information processing in home controller 100 according to the present embodiment.

With reference to FIG. 7, CPU 110 determines whether or not data has been received from home electrical appliances 200A-200E through the intermediary of communication interface 105 (step S102). In the case where the data has not been received from home electrical appliances 200A-200E (NO in step S102), CPU 110 repeats the processing starting from step S102.

In the case where the data has been received from home electrical appliances 200A-200E (YES in step S102), CPU 110 determines whether or not the data contains information indicating the electrical power consumption by home electrical appliances 200A-200E (step S 104). In the case where the data does not contain information indicating the electrical power consumption by home electrical appliances 200A-200E but contains information indicating an event related to home electrical appliances 200A-200E (NO in step S104), CPU 110 stores the information containing the event and the information indicating a home electrical appliance among home electrical appliances 200A-200E as a transmitting source into event table 101B in memory 101 (step S106), and repeats the processing starting from step S102.

In the case where the data contains information indicating the electrical power consumption by home electrical appliances 200A-200E (YES in step S104), CPU 110 stores the information indicating the electrical power consumption and the information indicating a home electrical appliance among home electrical appliances 200A-200E as a transmitting source into electrical power consumption table 101A in memory 101 (step S108). With reference to electrical power consumption table 101A, CPU 110 calculates a difference (change amount) between the electrical power consumption in the previous time and the electrical power consumption in the current time for the transmitting source appliance among home electrical appliances 200A-200E.

Alternatively, it is acceptable that CPU 110 calculates with reference to electrical power consumption table 101A, the difference (change amount) between the electrical power consumption in a precedent time older than the previous time and the electrical power consumption in the current time. Alternatively, it is acceptable that CPU 110 calculates with reference to electrical power consumption table 101A, a ratio (change rate) of the difference between the electrical power consumption in the previous time or the electrical power consumption in a precedent time older than the previous time and the electrical power consumption in the current time relative to the electrical power consumption in the previous time or the electrical power consumption in a precedent time older than the previous time. Alternatively, it is acceptable that CPU 110 calculates with reference to electrical power consumption table 101A, a fraction (change rate) of the difference between an average value of the electrical power consumption over several precedent times and the electrical power consumption in the current time relative to the sum of the electrical power consumption over several precedent times.

CPU 110 determines whether or not the change amount or the change rate is equal to or greater than a predefined value (step S110). It is acceptable for CPU 110 to determine whether or not an absolute value of the change amount is equal to or greater than the predefined value or to determine whether or not the change amount is equal to or greater than a predefined positive value.

In the case where the change amount is less than the predefined value (NO in step S110), CPU 110 repeats the processing starting from step S102. In the case where the change amount is equal to or greater than the predefined value (YES in step S110), CPU 110 causes display 102 to display a text and an image (a pop-up window) indicating that there is a great change in the electrical power consumption (step S112).

CPU 110 transmits the text and the image indicating that there is a great change in the electrical power consumption to television 200B through the intermediary of communication interface 105. CPU 110 causes speaker 107 to output a sound notifying that there is a great change in the electrical power consumption.

Thereafter, CPU 110 waits for a display instruction for displaying a detail screen from touch panel 106 or button 104 (step S114). In the case where the display instruction is not received (NO in step S114), CPU 110 repeats the processing starting from step S114. In the case where the display instruction is received (YES in step S114), CPU 110 determines, with reference to clock 108, whether or not a predefined time interval (for example, 30 seconds) has elapsed from the time where the change amount is equal to or greater than the predefined value (step S116). In the case where the predefined time interval has not elapsed (NO in step S116), CPU 110 repeats the processing starting from step S116.

In the case where the predefined time interval has elapsed (YES in step S116), as illustrated in FIG. 2, CPU 110 causes display 102 to display graph 102A indicating a change history of the electrical power consumption by the transmitting source appliance among home electrical appliances 200A-200E (step S118). CPU 110 reads, with reference to event table 101B, the latest event at the time where the change amount is equal to or greater than the predefined value. CPU 110 causes display 102 to display the latest event 102B at a position corresponding to the time where the change amount is equal to or greater than the predefined value or at a position corresponding to the date and time of the latest event. Alternatively, it is acceptable that CPU 110 causes display 102 to simultaneously display a plurality of events including the latest event 102B and several previous events at a position corresponding to the time where the change amount is equal to or greater than the predefined value or at a position corresponding to the date and time of the latest event.

CPU 110 transmits graph 102A indicating the change history of the electrical power consumption by the transmitting source appliance among home electrical appliances 200A-200E and the date and time corresponding to the latest event to television 200B through the intermediary of communication interface 105.

Thereafter, CPU 110 waits for a display termination instruction from touch panel 106 or button 104 (step S120). In the case where a “close” button 102C (FIG. 2) on touch panel 106 is pressed (YES in step S120), CPU 110 terminates the display of graph 102A and repeats the processing starting from step S102. In the case where “close” button 102C (FIG. 2) on touch panel 106 is not pressed (NO in step S120), CPU 110 repeats the processing of step S120.

The processing of step S112 and the processing of step S114 may be skipped. Also, the processing of step S116 may be skipped. FIG. 8 is a schematic view illustrating display 102 or 202 having graph 102A displayed immediately after (several seconds after) the change amount becomes equal to or greater than the predefined value.

With reference to FIG. 8, it is acceptable that graph 102A and event 102B are displayed on display 102 of home controller 100 and/or on display 202 of television 200B immediately after (several seconds after) the change amount becomes equal to or greater than the predefined value.

<Information Processing in Television 200B>

Hereinafter, the information processing in television 200B according to the present embodiment will be described. FIG. 9 is a flow chart illustrating a procedure of an information processing by television 200B according to the present embodiment.

With reference to FIG. 9, CPU 210 determines whether or not the notification information (the text and image indicating that there is a great change in the electrical power consumption) has been received from home controller 100 through the intermediary of communication interface 205 (step S202). In the case where the notification information has not been received (NO in step S202), CPU 210 repeats the processing starting from step S202.

In the case where the notification information has been received (YES in step S202), CPU 210 causes display 202 to display the text and image indicating that there is a great change in the electrical power consumption (step S204). Thereafter, CPU 210 waits for a display instruction for displaying a detail screen from the user through the intermediary of button 204 or a remote communication interface (not shown) (step S206).

In the case where the display instruction is not received (NO in step S206), CPU 210 repeats the processing starting from step S206. In the case where the display instruction is received (YES in step S206), CPU 210 requests time-series data from home controller 100 through the intermediary of communication interface 205 (step S208).

Thereafter, CPU 210 determines whether or not the graph and the information indicating that events have been received from home controller 100 through the intermediary of communication interface 205 (step S210). In the case where the graph and the information indicating that events have not been received from home controller 100 (NO in step S210), CPU 210 repeats the processing starting from step S210.

In the case where the graph and the information indicating that events have been received from home controller 100 (YES in step S210), as illustrated in FIG. 2, CPU 210 causes display 202 to display graph 102A indicating the change history of the electrical power consumption and the latest event 102B (step S212).

Thereafter, CPU 210 waits for a display termination instruction from the user through the intermediary of button 204 or a remote communication interface (not shown) (step S214). For example, in the case where “close” button 102C (FIG. 2) is selected (YES in step S214), CPU 210 terminates the display of graph 102A and repeats the processing starting from step S202. In the case where “close” button 102C (FIG. 2) is not selected (NO in step S214), CPU 210 repeats the processing of step S214. Alternatively, it is acceptable that “close” button 102C (FIG. 2) is not displayed and the display is terminated after a predefined time interval passes. In addition, the processing of steps S204 and S206 may be skipped.

### Embodiment 2

Hereinafter, Embodiment 2 of the present invention will be described. In network system 1 according to Embodiment 1 described above, home electrical appliances 200A-200E are configured to measure the electrical power consumption and transmit the electrical power consumption and events to home controller 100. In contrast, in a network system 1B according to the present embodiment, each of home electrical appliances 200A-200E does not transmit the electrical power consumption to home controller 100. Specifically, in place of home electrical appliances 200A-200E, a communication unit (smart tap) attached to an outlet for supplying electrical power to home electrical appliances 200A-200E is configured to measure the electrical power consumption by each of home electrical appliances 200A-200E and transmit the electrical power consumption to home controller 100.

Hereinafter, the description of a component which is the same as that in network system 1 according to Embodiment 1 will not be repeated.

<Overall Configuration of Network System>

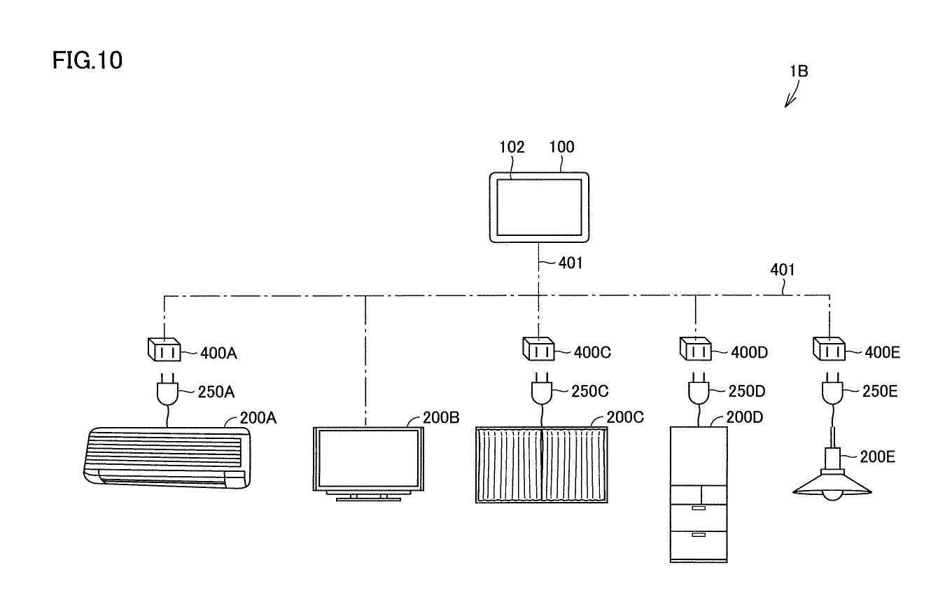

Firstly, the overall configuration of network system 1B according to the present embodiment will be described. FIG. 10 is a schematic view illustrating the overall configuration of network system 1B according to the present embodiment.

With reference to FIG. 10, network system 1B according to the present embodiment is disposed, for example, in a home or an office room. Network system 1B includes home electrical appliances (electrical devices) such as an air conditioner 200A set in a living room, a television 200B set in a living room, a curtain device 200C set in a living room, a refrigerator 200D set in a kitchen, and a light 200E set in a dining room. It is acceptable for network system 1B to include the other home electrical appliances.

In network system 1B according to the present embodiment, a communication unit 400A for air conditioner 200A is disposed between air conditioner 200A and an outlet for air conditioner 200A. In other words, communication unit 400A is plugged into the outlet for air conditioner 200A, and thereafter an adaptor 250A for air conditioner 200A is plugged into communication unit 400A. Similarly, a communication unit 400C for curtain device 200C is disposed between curtain device 200C and an outlet for curtain device 200C. In other words, communication unit 400C is plugged into the outlet for curtain device 200C, and thereafter an adaptor 250C for curtain device 200C is plugged into communication unit 400C. A communication unit 400D for refrigerator 200D is disposed between refrigerator 200D and an outlet for refrigerator 200D. In other words, communication unit 400D is plugged into the outlet for refrigerator 200D, and thereafter an adaptor 250D for refrigerator 200D is plugged into communication unit 400D. A communication unit 400E for light 200E is disposed between light 200E and an outlet for light 200E. In other words, communication unit 400E is plugged into the outlet for light 200E, and thereafter an adaptor 250E for light 200E is plugged into communication unit 400E.

Network system 1B includes home controller 100 configured to control home electrical appliances 200A-200E. Home controller 100 is capable of communicating data with communication units 400A-400E through the intermediary of wired or wireless network 401. For example, a wireless LAN (Local Area Network), ZigBee (registered trademark), Bluetooth (registered trademark), a wired LAN, or a PLC (Power Line Communications) may be used by home controller 100 as network 401. Home controller 100 may be portable, or may be detachably installed on a base placed on a table, or may be fixed on a wall of a room.

<Operation Summary of Network System>

Hereinafter, operations of network system 1B according to the present invention will be summarized.

With reference to FIG. 10 and FIG. 2, through the intermediary of network 401, home controller 100 according to the present embodiment receives the electrical power consumption by home electrical appliances 200A-200E from the communication units 400A-400E connected respectively to home electrical appliances 200A-200E disposed in the home.

Home controller 100 determines whether or not there is a great change in the electrical power consumption of home electrical appliances 200A-200E on the basis of a collection of a change history of the electrical power consumption of home electrical appliances 200A-200E. For example, home controller 100 determines whether or not a change amount or a change rate in the electrical power consumption is greater than a predefined range.

Home controller 100 causes graph 102A indicating changes in the electrical power consumption of a home electrical appliance to be displayed on display 102 when the home electrical appliance has a great change in the electrical power consumption. Alternatively, home controller 100 causes graph 102A to be displayed on display 202 of television 200B.

More specifically, home controller 100 causes display 102 or display 202 to display an image (a pop-up window) indicating that there is a great change in the electrical power consumption. Home controller 100 causes display 102 or display 202 to display graph 102A in accordance with a display instruction for displaying a detail screen from a user.

Home controller 100 makes a display mode of a portion of the displayed graph where there is a great change in the electrical power consumption different from the display mode of the other portions. For example, home controller 100 may thicken lines in the portion where there is a great change in the electrical power consumption, may change the color of the lines, or may blink the lines. Alternatively, it is acceptable to circumscribe a portion where there is a great change in the electrical power consumption with a graphic representation such as a circle or the like.

It is acceptable that home controller 100 displays graph 102A only when the change amount or the change rate in the electrical power consumption becomes great positively, and it is also acceptable that home controller 100 displays graph 102A when the change amount or the change rate in the electrical power consumption becomes great either positively or negatively.

As mentioned above, network system 1B according to the present embodiment can notify the user that there is a great change in the electrical power consumption of home electrical appliances 200A-200E when it occurs. In other words, a user is made aware of the electrical power consumption at a timing when there is a great change in the electrical power consumption.

Hereinafter, the specific configuration of network system 1B for implementing the functions mentioned above will be described in detail.

<Hardware Configuration of Home Controller 100>

An example of a hardware configuration of home controller 100 according to the present embodiment will be described. Since the hardware configuration of home controller 100 according to the present embodiment is the same as the hardware configuration of home controller 100 according to Embodiment 1 as illustrated in FIG. 3, the description thereof will not be repeated. However, data to be stored in memory 101 and the processing to be executed by CPU 110 are respectively different from those in Embodiment 1.

Memory 101 stores a control program to be executed by CPU 110 and an electrical power consumption table 101A. With reference to FIG. 4, electrical power consumption table 101A stores the name of each home electrical appliance, the location where each home electrical appliance is disposed, and the electrical power consumption for each of home electrical appliances 200A-200E in association with each home electrical appliance ID. More specifically, electrical power consumption table 101A stores the value of the electrical power consumption received from communication units 400A, 400C, 400D and 400E and television 200B in association with the date and time at which the value of the electrical power consumption has been received (measured).

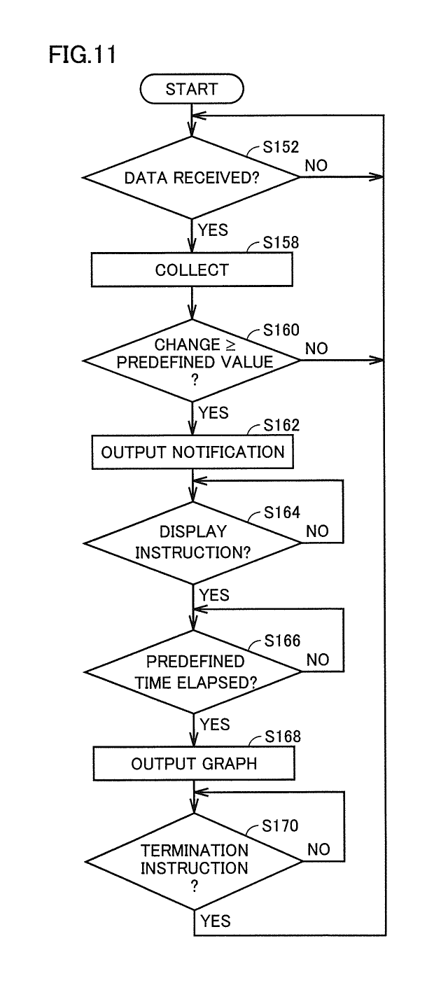

CPU 110 executes an information processing procedure and the like illustrated in FIG. 11, which will be described hereinafter, through executing various programs stored in memory 101.

<Hardware Configuration of Television 200B>

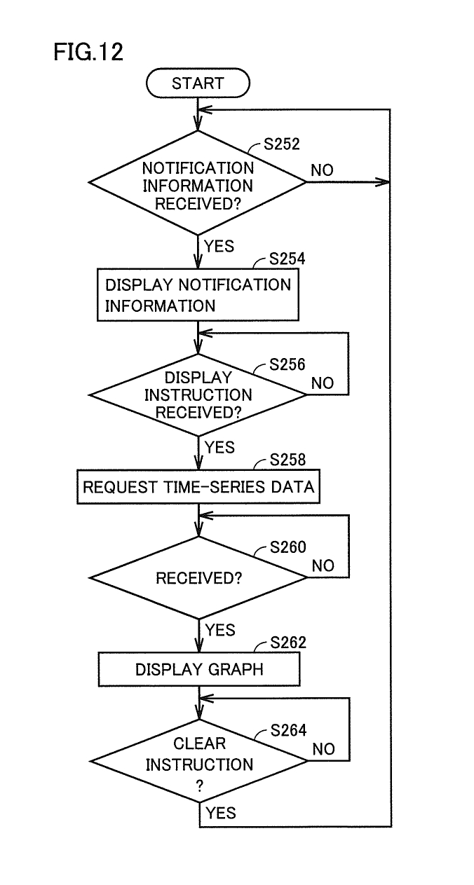

An example of a hardware configuration of television 200B according to the present embodiment will be described. Since the hardware configuration of television 200B is the same as the hardware configuration of television 200B according to Embodiment 1 as illustrated in FIG. 6, the description thereof will not be repeated. CPU 210 executes an information processing procedure in FIG. 12, which will be described hereinafter, through executing various programs stored in memory 201.

<Communication Units 400A-400E>

Similarly to television 200B illustrated in FIG. 6, communication units 400A-400E according to the present embodiment may be provided with sensor 209 connected respectively to home electrical appliances 200A-200E for measuring the electrical power consumption thereof, and communication interface 205 for transmitting the measured electrical power consumption to home controller 100.

<Information Processing in Home Controller 100>

Hereinafter, the information processing in home controller 100 according to the present embodiment will be described. FIG. 11 is a flow chart illustrating a procedure of the information processing in home controller 100 according to the present embodiment.

With reference to FIG. 11, CPU 110 determines whether or not data has been received from any communication unit 400A, 400C, 400D or 400E or from television 200B (hereinafter, all will be collectively referred to as communication units) through the intermediary of communication interface 105 (step S152). In the case where the data has not been received from communication units (NO in step S152), CPU 110 repeats the processing starting from step S152.

In the case where the data has been received from the communication units (YES in step S152), CPU 110 stores, into electrical power consumption table 101A in memory 101, the information indicating the electrical power consumption and the information for identifying a home electrical appliance among home electrical appliances 200A-200E which corresponds to the transmitting source communication unit, both of which are contained in the data (step S158). With reference to electrical power consumption table 101A, CPU 110 calculates a difference (change amount) between the electrical power consumption in the previous time and the electrical power consumption in the current time for the home electrical appliance among home electrical appliances 200A-200E which corresponds to the transmitting source communication unit.

Alternatively, it is acceptable that CPU 110 calculates with reference to electrical power consumption table 101A, the difference (change amount) between the electrical power consumption in a precedent time older than the previous time and the electrical power consumption in the current time. Alternatively, it is acceptable that CPU 110 calculates with reference to electrical power consumption table 101A, a ratio (change rate) of the difference between the electrical power consumption in the previous time or the electrical power consumption in a precedent time older than the previous time and the electrical power consumption in the current time relative to the electrical power consumption in the previous time or the electrical power consumption in a precedent time older than the previous time. Alternatively, it is acceptable that CPU 110 calculates with reference to electrical power consumption table 101A, a fraction (change rate) of the difference between an average value of the electrical power consumption over several precedent times and the electrical power consumption in the current time relative to the sum of the electrical power consumption over several precedent times.

CPU 110 determines whether or not the change amount is equal to or greater than a predefined value (step S160). It is acceptable for CPU 110 to determine whether or not an absolute value of the change amount is equal to or greater than the predefined value or to determine whether or not the change amount is equal to or greater than a predefined positive value.

In the case where the change amount is less than the predefined value (NO in step S160), CPU 110 repeats the processing starting from step S152. In the case where the change amount is equal to or greater than the predefined value (YES in step S160), CPU 110 causes display 102 to display a text and an image (a pop-up window) indicating that there is a great change in the electrical power consumption (step S162).

CPU 110 transmits the text and the image indicating that there is a great change in the electrical power consumption to television 200B through the intermediary of communication interface 105. CPU 110 causes speaker 107 to output a sound notifying that there is a great change in the electrical power consumption.

Thereafter, CPU 110 waits for a display instruction for displaying a detail screen from touch panel 106 or button 104 (step S164). In the case where the display instruction is not received (NO in step S164), CPU 110 repeats the processing starting from step S164. In the case where the display instruction is received (YES in step S164), CPU 110 determines, with reference to clock 108, whether or not a predefined time interval (for example, 30 seconds) has elapsed from the time where the change amount is equal to or greater than the predefined value (step S166). In the case where the predefined time interval has not elapsed (NO in step S166), CPU 110 repeats the processing starting from step S166.

In the case where the predefined time interval has elapsed (YES in step S166), as illustrated in FIG. 2, CPU 110 causes display 102 to display graph 102A indicating a change history of the electrical power consumption of home electrical appliances 200A-200E corresponding to the transmitting source communication units (step S 168). CPU 110 transmits graph 102A indicating the change history of the electrical power consumption of home electrical appliances 200A-200E corresponding to the transmitting source communication units to television 200B through the intermediary of communication interface 105.

Thereafter, CPU 110 waits for a display termination instruction from touch panel 106 or button 104 (step S170). In the case where “close” button 102C (FIG. 2) on touch panel 106 is selected (YES in step S170), CPU 110 terminates the display of graph 102A and repeats the processing starting from step S152. In the case where “close” button 102C (FIG. 2) on touch panel 106 is not selected (NO in step S170), CPU 110 repeats the processing of step S170.

The processing of step S162 and the processing of step S164 may be skipped. Also, the processing of step S166 may be skipped. With reference to FIG. 8, it is acceptable that graph 102A is displayed on display 102 and/or on television 200B immediately after (several seconds after) the change amount becomes equal to or greater than the predefined value.

<Information Processing in Television 200B>

Hereinafter, the information processing in television 200B according to the present embodiment will be described. FIG. 12 is a flow chart illustrating a procedure of an information processing by television 200B according to the present embodiment.

With reference to FIG. 12, CPU 210 determines whether or not the notification information (the text and image indicating that there is a great change in the electrical power consumption) has been received from home controller 100 through the intermediary of communication interface 205 (step S252). In the case where the notification information has not been received (NO in step S252), CPU 210 repeats the processing starting from step S252.

In the case where the notification information has been received (YES in step S252), CPU 210 causes display 202 to display the text and image indicating that there is a great change in the electrical power consumption (step S254). Thereafter, CPU 210 waits for a display instruction for displaying a detail screen from the user through the intermediary of button 204 or a remote communication interface (not shown) (step S256).

In the case where the display instruction is not received (NO in step S256), CPU 210 repeats the processing starting from step S256. In the case where the display instruction is received (YES in step S256), CPU 210 requests time-series data from home controller 100 through the intermediary of communication interface 205 (step S258).

Thereafter, CPU 210 determines whether or not the information indicating the graph has been received from home controller 100 through the intermediary of communication interface 205 (step S260). In the case where the information about the graph has not been received from home controller 100 (NO in step S260), CPU 210 repeats the processing starting from step S260.

In the case where the information about the graph has been received from home controller 100 (YES in step S260), as illustrated in FIG. 2, CPU 210 causes display 202 to display graph 102A indicating the change history of the electrical power consumption (step S262).

Thereafter, CPU 210 waits for a display termination instruction from the user through the intermediary of button 204 or a remote communication interface (not shown) (step S264). For example, in the case where “close” button 102C (FIG. 2) is not selected (YES in step S264), CPU 210 terminates the display of graph 102A and repeats the processing starting from step S252. In the case where “close” button 102C (FIG. 2) is selected (NO in step S264), CPU 210 repeats the processing of step S264. Alternatively, it is acceptable that “close” button 102C (FIG. 2) is not displayed and the display is terminated after a predefined time interval passes. In addition, the processing of steps S254 and S256 may be skipped.

### Other Embodiments

It is needless to say that the present invention is applicable to the case that the present invention can be accomplished by supplying a program to home controller 100, home electrical appliances 200A-200E, a cell phone or the like. Moreover, in the case where a storage medium stored with a program representing software for accomplishing the present invention is supplied to a system or a device, and a computer (or a CPU and/or a MPU) in the system or the device reads the program code stored in the storage medium and executes the program, it is possible to obtain the effects of the present invention.

In this case, reading the program code from the storage medium is equivalent to implementing the functions of the abovementioned embodiments, and the storage medium storing the program code constitutes the present invention.

Moreover, it is needless to say that the present invention includes not only the case where executing the program code which is read by a computer implements the functions of the abovementioned embodiments but also the case where an OS (operating system) or the like running on the computer executes a part of or the entire part of actual processing in accordance with instructions of the program code to implement the functions of the abovementioned embodiments.

Furthermore, it is needless to say that the present invention includes such a case in which after the program code read from the storage medium is written in a memory disposed in a function expansion board which is inserted into a computer or a function expansion unit which is connected to a computer, a CPU or the like included in the function expansion board or the function expansion unit executes a part of or the entire part of actual processing in accordance with instructions of the program code to implement the functions of the abovementioned embodiments through the processing.

It should be understood that the embodiments disclosed herein have been presented for the purpose of illustration and description but not limited in all aspects. It is intended that the scope of the present invention is not limited to the description above but defined by the scope of the claims and encompasses all modifications equivalent in meaning and scope to the claims.

### REFERENCE SIGNS LIST

1, 1B: network system; 100: home controller; 101: memory; 101A: electrical power consumption table; 101B: event table; 102: display; 102A: graph; 102B: event; 102C: “close” button; 103: tablet; 104: button; 105: communication interface; 106: touch panel; 107: speaker; 108: clock; 110: CPU; 200A: air conditioner; 200B: television; 200C: curtain device; 200D: refrigerator; 200E: light; 201: memory; 202: display; 204: button; 205: communication interface; 207: speaker; 208: clock; 209: sensor; 210: CPU; 250A-205E: adaptor; 400A-400E: communication unit; 401: network

1. A controller comprising:
a communication interface configured to receive an electrical power consumption of a plurality of devices;
a memory configured to store changes in the electrical power consumption of said plurality of devices; and
a processor configured to determine whether or not a change amount or a change rate in said electrical power consumption is greater than a predefined range for each of said plurality of devices and output information indicating the electrical power consumption of a device for which the change amount or the change rate in said electrical power consumption is greater than said predefined range.

2. The controller according to claim 1, further comprising a display, wherein:
when the change amount or the change rate in said electrical power consumption of a device is greater than said predefined range, said processor causes said display to display the information indicating the electrical power consumption of the device for which the change amount or the change rate in said electrical power consumption is greater than said predefined range.

3. The controller according to claim 2, further comprising an input unit, wherein:
said processor causes said display to display an image of notification when the change amount or the change rate in said electrical power consumption of a device is greater than said predefined range, and
said processor causes said display to display the information indicating the electrical power consumption of the device for which the change amount or the change rate in said electrical power consumption is greater than said predefined range in accordance with a display instruction input from said input unit.

4. The controller according to claim 1, wherein:
said communication interface is capable of communicating with an external display device; and
said processor causes, through the intermediary of said communication interface, said external display device to display an image of notification when the change amount or the change rate in said electrical power consumption of a device is greater than said predefined range; and
said processor causes, through the intermediary of said communication interface, said external display device to display the information indicating the electrical power consumption of the device for which the change amount or the change rate in said electrical power consumption is greater than said predefined range in accordance with an input of a display instruction.

5. The controller according to claim 1, wherein said processor outputs a graph indicating temporal changes in said electrical power consumption as the information indicating the electrical power consumption of the device for which the change amount or the change rate in said electrical power consumption is greater than said predefined range.

6. The controller according to claim 5, wherein said processor outputs the graph by making a portion of the graph where the change amount or the change rate of said electrical power consumption is greater than said predefined range different from the other portions thereof.

7. The controller according to claim 1, wherein said processor, through the intermediary of said communication interface, receives the electrical power consumption from each of said plurality of devices.

8. The controller according to claim 7, wherein:
said processor receives, through the intermediary of said communication interface, instructions input from each device of said plurality of devices;
said processor stores in said memory said instructions associated with said device; and
said processor outputs at least one latest instruction associated with said device for which the change amount or the change rate in said electrical power consumption is greater than said predefined range together with the information indicating the electrical power consumption of the same device for which the change amount or the change rate in said electrical power consumption is greater than said predefined range.

9. The controller according to claim 1, wherein said processor, through the intermediary of said communication interface, receives said electrical power consumption from a plurality of communication units configured to measure the electrical power consumption of each of said plurality of devices.

10. A network system comprising a plurality of devices and a controller,
each of said plurality of devices being configured to transmit an electrical power consumption to said controller, and
said controller including:
a communication interface configured to receive said electrical power consumption from said plurality of devices;
a memory configured to store changes in the electrical power consumption of said plurality of devices; and
a processor configured to determine whether or not a change amount or a change rate in said electrical power consumption is greater than a predefined range for each of said plurality of devices and output information indicating the electrical power consumption of a device for which the change amount or the change rate in said electrical power consumption is greater than said predefined range.

11. A network system comprising a plurality of devices, a plurality of measuring units configured to measure an electrical power consumption of each of the plurality of devices, and a controller,
said plurality of measuring units each being configured to transmit the electrical power consumption of each of said plurality of devices to said controller, and
said controller including:
a communication interface configured to receive said electrical power consumption of said plurality of devices from said plurality of measuring units;
a memory configured to store changes in the electrical power consumption of said plurality of devices; and
a processor configured to determine whether or not a change amount or a change rate in said electrical power consumption is greater than a predefined range for each of said plurality of devices and output information indicating the electrical power consumption of a device for which the change amount or the change rate in said electrical power consumption is greater than said predefined range.

12. An information processing method for a controller including a communication interface, a memory and a processor, comprising the steps of:
receiving, by said processor, an electrical power consumption of each of a plurality of devices through the intermediary of said communication interface;
storing, by said memory, changes in the electrical power consumption of each of said plurality of devices;
determining, by said processor, whether or not a change amount or a change rate in said electrical power consumption is greater than a predefined range for each of said plurality of devices; and
outputting, by said processor, information indicating the electrical power consumption of a device for which the change amount or the change rate in said electrical power consumption is greater than said predefined range.
